(19) United States
(12) Patent Application Publication
(10) Pub. No.: US 2018/0304887 A1
(43) Pub. Date: Oct. 25, 2018

(54) METHOD AND DEVICE FOR REDUCING A RISK OF A COLLISION OF A MOTOR VEHICLE WITH AN OBJECT

(71) Applicant: Robert Bosch GmbH, Stuttgart (DE)

(72) Inventor: Stefan Nordbruch, Kornwestheim (DE)

(21) Appl. No.: 15/768,699

(22) PCT Filed: Oct. 5, 2016
(86) PCT No.: PCT/EP2016/073748

§ 371 Date: Apr. 16, 2018

(30) Foreign Application Priority Data
Oct. 22, 2015 (DE) 10 2015 220 640.8

(51) Int. Cl. B60W 30/09; G08G 1/16

(52) U.S. Cl. CPC B60W 30/09; B60W 2550/10; G08G 1/165; G08G 1/168

(57) ABSTRACT

A method for reducing a risk of a collision of a motor vehicle with an object, including specifying a safety area, which defines a delimited subarea of a current motor vehicle surroundings of a motor vehicle driving within a parking facility, ascertaining a location within a parking facility, which is classified as critical, adapting the specified safety area while the motor vehicle is driving toward the critical location in such a way that the critical location lies within the adapted safety area, monitoring the adapted safety area while the motor vehicle is driving toward the critical location for an object moving into the adapted safety area and/or for an object located within the adapted safety area, and controlling a performance of one or multiple safety actions based on the monitoring in order to reduce a risk of a collision of the motor vehicle with the object.

### FIELD

The present invention relates to a method and a device for reducing a risk of a collision of a motor vehicle with an object. Furthermore, the present invention relates to a motor vehicle, to a parking facility and to a computer program.

### BACKGROUND INFORMATION

German Patent Application No. DE 10 2012 222 562 A1 describes a system for managed parking areas for transferring a vehicle from a starting position to a destination position.

During such a transfer, it is important that the vehicle does not collide with objects, for example persons or other vehicles.

### SUMMARY

An object of the present invention is to provide for the efficient reduction of a risk of a collision of a motor vehicle with an object.

Advantageous developments of the present invention are described herein.

According to one aspect of the present invention, an example method is provided for reducing a risk of a collision of a motor vehicle with an object, including the following steps:
specifying a safety area, which defines a delimited subarea of a current motor vehicle surroundings of a motor vehicle driving within a parking facility,
ascertaining a location within a parking facility, which is classified as critical,
adapting the specified safety area while the motor vehicle is driving toward the critical location in such a way that the critical location lies within the adapted safety area,
monitoring the adapted safety area while the motor vehicle is driving toward the critical location for an object moving into the adapted safety area and/or for an object located within the adapted safety area,
controlling a performance of one or multiple safety actions based on the monitoring in order to reduce a risk of a collision of the motor vehicle with the object.

According to another aspect of the present invention, an example device is provided for reducing a risk of a collision of a motor vehicle with an object, including:
a specification device for specifying a safety area, which defines a delimited subarea of a current motor vehicle surroundings of a motor vehicle driving within a parking facility,
an ascertainment device for ascertaining a location within a parking facility, which is classified as critical,
an adaptation device for adapting the specified safety area while the motor vehicle is driving toward the critical location in such away that the critical location lies within the adapted safety area,
a monitoring device for monitoring the adapted safety area while the motor vehicle is driving toward the critical location for an object moving into the adapted safety area and/or for an object located within the adapted safety area,
a control unit for controlling a performance of one or multiple safety actions based on the monitoring in order to reduce a risk of a collision of the motor vehicle with the object.

According to another aspect of the present invention, a motor vehicle is provided, which comprises the device of the present invention.

According to another aspect of the present invention, a parking facility for motor vehicles is provided, the parking facility comprising the device of the present invention.

According to yet another aspect of the present invention, a computer program is provided, comprising program code for implementing the method according to the present invention when the computer program is executed on a computer.

The present invention thus includes in particular and inter alia including a location, which is classified as critical and which is located within a parking facility, in a safety area in order thus to be able to monitor this critical location efficiently. This is accomplished in that the specified safety area is adapted in such a way that the critical location lies within the adapted safety area. This advantageously ensures that a critical location, which is located within the parking facility, is monitored while the motor vehicle is driving toward the critical location so that when needed it is possible to perform one or multiple safety actions based on the monitoring.

This in particular yields the technical advantage of being able efficiently to reduce a risk of a collision of a motor vehicle with an object, which is located within the adapted safety area and/or with an object, which is moving into the adapted safety area.

A motor vehicle surroundings in particular refers to an area around the motor vehicle up to a distance of 3 m, for example 2 m, preferably 1.5 m, for example 1 m.

A parking facility in the sense of the present invention may also be called a parking area and is used as an area for parking motor vehicles. The parking facility thus forms in particular a contiguous area, which has multiple parking spaces (in the case of a parking facility on private property) or parking stalls (in the case of a parking facility on public property). According to one specific embodiment, the parking facility is developed as a car park. According to one specific embodiment, the parking facility is developed as a parking garage.

One specific embodiment provides for the ascertainment of the critical location to comprise reading out a location classified as critical from a digital map of the parking facility.

This yields in particular the technical advantage of being able to ascertain a critical location efficiently. There is a provision for example for transmitting the digital map to the motor vehicle via a communication network. There is a provision for example for the digital map to be already stored in the device or in the motor vehicle.

Another specific embodiment provides for the ascertainment of the critical location to comprise a surroundings analysis of surroundings data for possible critical locations, the surroundings data being provided by one or multiple surround sensors that sensed the current motor vehicle surroundings. This yields in particular the technical advantage of being able to detect possible critical locations within the parking facility efficiently.

According to one specific embodiment, the surround sensor(s) is/are one or multiple surround sensors of the motor vehicle and/or of the parking facility. That is to say that for example a current motor vehicle surroundings is sensed by one or by multiple surround sensors of the motor vehicle in order to ascertain corresponding surroundings data. That is to say for example that a current surroundings of the motor vehicle is sensed by one or multiple surround sensors of the parking facility in order to ascertain corresponding surroundings data.

The surroundings data thus ascertained are then used for the analysis of the surroundings. That is to say, for example, that the parking facility comprises multiple surround sensors that are situated within the parking facility.

A surround sensor in the sense of the present invention is for example one of the following surround sensors: radar sensor, lidar sensor, laser sensor, ultrasonic sensor, infrared sensor, magnetic sensor, video sensor or light-barrier sensor.

Another specific embodiment provides for a current location of the object on the driving path and/or a location at which the object will move into the driving path, to be classified as a critical location or as critical locations if the surroundings analysis has determined that an object moved or will move into a driving path of the motor vehicle.

This yields in particular the technical advantage of being able efficiently to detect even critical locations that arise spontaneously. For if a person steps into the driving path of the motor vehicle for example, then the location at which the person steps into the driving path of the motor vehicle is a critical location that should be monitored in order to prevent a possible collision with the person.

An object in the sense of the present invention is, for example, another motor vehicle, a person or an animal or a stationary infrastructure element, which is comprised by the parking facility for example (parking facility infrastructure element). The stationary infrastructure element is for example a pillar, a curbstone or a wall.

According to the present invention, multiple critical locations may be provided. That is to say that when the critical location is mentioned in the singular, the plural should always be read as well and vice versa.

Another specific embodiment provides for a location of the parking facility infrastructure element to be classified as a critical location if the surroundings analysis has determined that at least one parking facility infrastructure element is located in the surroundings of the motor vehicle, the at least one parking facility infrastructure element being an element from the following group of parking facility infrastructure elements: door, ramp, ingress, entrance, egress, exit, barrier, curve, pillar.

This yields in particular the technical advantage of making it possible to monitor critical parking facility infrastructure elements efficiently. For the aforementioned parking facility infrastructure elements are critical locations in that other motor vehicles or persons are located at these parking facility infrastructure elements or leave or enter the parking facility via these locations. Thus, it is possible, for example, that a person steps through the door. Since surround sensors of the motor vehicle are normally not able to see through a door, it is technically expedient to include the door in the safety area in order to monitor it separately and with priority in order to be prepared efficiently for the event in which a person steps through the door.

Another specific embodiment provides for the ascertainment of the critical location to comprise the analysis of inclination data of an inclination sensor comprised by the motor vehicle to determine an inclination of the motor vehicle, where, if a detected inclination is greater than or greater than or equal to a predetermined inclination threshold value, a determination is made that the motor vehicle is currently located on a ramp so that the ramp is classified as a critical location.

This yields in particular the technical advantage of being able to ascertain a critical location, in is case the ramp, efficiently. For surround sensors of a motor vehicle are normally not able to see beyond the ramp, while an object could be located at the end of the ramp for example. It is thus technically expedient to include the ramp as a critical location in the safety area that is monitored.

One specific embodiment provides for the adaptation of the specified safety area to include that the specified safety area is oriented toward the critical location.

This yields in particular the technical advantage of making it possible to perform the adaptation efficiently.

The orientation includes here in particular that the adapted safety area has a preferred orientation in the direction of the critical location. This in analogous to a radar lobe of a radar signal or generally to an antenna lobe of an antenna signal. That is to say that the orientation comprises providing the safety area with a preferential direction, which points in the direction of the critical location.

Another specific embodiment provides for the adaptation to be initiated and carried out in response to a trigger signal.

This yields in particular the technical advantage that the adaptation is carried out even when for example a surroundings analysis itself was not yet able to ascertain a critical location. Thus it may happen for example that the motor vehicle itself was not able to detect a critical location within the parking facility, whereas outside of the motor vehicle it was indeed possible to detect such a critical location by way of the device. If the device outside of the motor vehicle then transmits a trigger signal to the motor vehicle, which comprises its own vehicle-internal device, then the device of the motor vehicle is able to initiate and carry out the adaptation in response to the trigger signal.

That is to say that according to one specific embodiment the trigger signal is received and transmitted via a communication network. It is received by the motor vehicle. It is transmitted by the device of the parking facility.

According to one specific embodiment, the communication network comprises a mobile telephony communication network and/or a WLAN communication network and/or a communication network according to the LoRa standard. “LoRa” stands for “low power wide-range communication”. Such a communication network may also be referred to as a LoRa communication network.

In one specific embodiment, a communication via the communication network is encrypted.

One specific embodiment provides for a communication interface for communication via a communication network.

According to one specific embodiment, the communication interface is comprised by the device.

According to one specific embodiment, the communication interface is comprised by the parking facility.

In another specific embodiment, the motor vehicle comprises the communication interface.

According to one specific embodiment, both the parking facility as well as the motor vehicle comprise a communication interface.

According to one specific embodiment, the motor vehicle comprises one or more surround sensors.

According to another specific embodiment, the parking facility comprises one or more surround sensors.

In one specific embodiment, the device comprises one or more surround sensors.

A critical location in the sense of the present invention indicates in particular a location that bears a hazard for the motor vehicle. A critical location may thus be referred to in particular as a hazardous location. A hazardous or critical location has in particular an hazard value that is greater than or greater than or equal to a predetermined hazard threshold value.

One specific embodiment provides for the predetermined safety area to have a rectangular shape, a circular shape or an oval shape and to surround the motor vehicle at least partially, in particular completely, the adaptation comprising an enlargement of the rectangular shape, the circular shape or the oval shape.

This yields in particular the technical advantage of making it possible to perform the adaptation efficiently.

One specific embodiment provides for only a section of the rectangular shape and/or the circular shape and/or the oval shape to be enlarged in such a way that this enlarged section comprises the critical location(s).

An enlargement in the sense of this specification indicates for example a scaled enlargement.

An enlargement in the sense of this specification indicates for example a change of the original shape of the safety area in such a way that the changed shape is greater than the original shape. Enlarging in this connection means in particular that an area of the safety area is enlarged. The present invention thus provides for example for changing a circular shape to a rectangular shape.

One specific embodiment provides for the device for reducing a risk of a collision of a motor vehicle with an object to be designed or configured to carry out or implement the method for reducing a risk of a collision of a motor vehicle with an object.

According to one specific embodiment, the method for reducing a risk of a collision of a motor vehicle with an object is carried out or implemented by the device for reducing a risk of a collision of a motor vehicle with an object.

Technical functionalities and features of the device derive analogously from corresponding technical functionalities and features of the method and vice versa.

According to one specific embodiment, the motor vehicle is designed or configured to carry out or implement the method of the present invention.

According to another specific embodiment, the parking facility is designed or configured to carry out or implement the method of the present invention.

According to one specific embodiment, for ascertaining the critical location, the ascertainment device is designed to read out a location classified as critical from a digital map of the parking facility.

According to one specific embodiment, for ascertaining the critical location, the ascertainment device is designed to perform a surroundings analysis of the current motor vehicle surroundings for possible critical locations.

Another specific embodiment provides for the ascertainment device to be designed to classify a current location of the object on the driving path and/or a location, at which the object will move into the driving path, as a critical location or as critical locations if the surroundings analysis has determined that an object has moved or will move into a driving path of the motor vehicle.

Another specific embodiment provides for the ascertainment device to be designed to classify a location of the parking facility infrastructure element as a critical location if the surroundings analysis has determined that at least one parking facility infrastructure element is located in the surroundings of the motor vehicle, the at least one parking facility infrastructure element being an element from the following group of parking facility infrastructure elements: door, ramp, ingress, entrance, egress, exit, barrier, curve, pillar.

Another specific embodiment provides for the ascertainment device to be designed to analyze inclination data of an inclination sensor comprised by the motor vehicle to determine an inclination of the motor vehicle in order to ascertain the critical location, the ascertainment device being further designed, if a detected inclination is greater than or greater than or equal to a predetermined inclination threshold value, to determine that the motor vehicle is currently located on a ramp and to classify the ramp as a critical location.

Another specific embodiment provides for the adaptation device to be designed to orient the specified safety area to the critical location for the purpose of adapting the specified safety area.

Another specific embodiment provides for the adaptation device to be designed to initiate and carry out the adaptation in response to a trigger signal.

For adapting a rectangular, circular or oval safety area that surrounds the motor vehicle at least partially, in particular entirely, another specific embodiment provides for the adaptation device to be designed to enlarge the rectangular shape, the circular shape or the oval shape.

One specific embodiment provides for the one or the multiple safety actions to be elements of the following group of safety actions: reducing a current motor vehicle speed, preparing a braking system of the motor vehicle for a braking action, performing a surroundings analysis of the adapted safety area, performing an emergency stop.

The provision of reducing a current motor vehicle speed yields in particular the technical advantage of being able efficiently to reduce a collision risk even further. This yields in particular the technical advantage of being able to reduce an accident severity on account of the reduced motor vehicle speed in the event that a collision should occur.

In particular the preparation of the braking system of the motor vehicle for a braking action has in particular the technical advantage of efficiently reducing a reaction time of the braking system when a braking torque is requested. This advantageously shortens a braking distance in an efficient manner.

In particular the performance of a surroundings analysis of the adapted safety area has in particular the technical advantage of making it possible to determine efficiently in what direction the object will move in relation to the motor vehicle. In particular, this advantageously makes it possible to estimate or determine in an efficient manner the magnitude of a risk of a possible collision. The performance of a surroundings analysis in particular corresponds to a repetition of a surroundings analysis of the adapted safety area. This yields for example the technical advantage of making it possible efficiently to detect possible errors in a previous surroundings analysis so that then an appropriate action may be taken.

In particular the performance of an emergency stop has in particular the technical advantage of making it possible efficiently to reduce a risk of collision even further. If a collision should occur, this makes it possible in particular efficiently to reduce an accident severity even further. Am emergency stop refers in particular to a stoppage of the motor vehicle using the highest possible braking torque (full brake application).

Another specific embodiment provides for the performance to comprise a remote control of the one safety action or of one or multiple of the multiple safety actions.

This yields in particular the technical advantage that it is not necessary for the motor vehicle itself to be designed to decide autonomously which of the safety actions it should perform. For this is done outside of the vehicle, that is, the motor vehicle is remote-controlled. The remote control comprises in particular a transmission of remote control commands to the motor vehicle via a communication network, in response to which the motor vehicle is able to perform and/or performs the one or the multiple safety actions.

Thus, one specific embodiment provides for the motor vehicle to be remote-controlled in such a way that a current motor vehicle speed is reduced. One specific embodiment provides in particular for controlling the motor vehicle remotely in such a way that a braking system of the motor vehicle is prepared for a braking action. One specific embodiment provides in particular for controlling the motor vehicle remotely in such a way that the motor vehicle stops, that is, performs an emergency stop. That is to say that the motor vehicle is stopped by remote control.

According to one specific embodiment, the monitoring comprises sensing the adapted safety area using one or multiple surround sensors (for example of the motor vehicle and/or of the parking facility) in order to ascertain surroundings data corresponding to the sensed safety area, which are then provided for an analysis of the surroundings.

According to one specific embodiment, the motor vehicle drives in driverless fashion. For example, the motor vehicle drives driverlessly within the parking facility.

A driverless travel of the motor vehicle comprises controlling the motor vehicle remotely. According to one specific embodiment, such a driverless travel of the motor vehicle comprises that the motor vehicle drives autonomously, that is, independently. According to one specific embodiment, an autonomous travel of the motor vehicle provides for the motor vehicle to be at least partially supported, that is, assisted, for this purpose. That is to say that the motor vehicle may be or is assisted in its autonomous travel for example. Such assistance comprises for example the transmission of travel data to the motor vehicle via a communication network, based on which the motor vehicle is able to drive autonomously. Such data for example comprise map data of a digital map of the parking facility, setpoint trajectory data of a setpoint trajectory to be driven by the motor vehicle, destination position data of a destination position within the parking facility to which the motor vehicle is to drive.

According to one specific embodiment, the motor vehicle performs an automatic parking process within the parking facility. That is to say that the travel of the motor vehicle along the setpoint trajectory is comprised by an automatic parking process. Such an automatic parking process may also be referred to as an AVP process. “AVP” stands for “automatic valet parking” and may be translated as automatic parking process.

In the context of such an AVP process, the motor vehicle drives automatically (remote-controlled or autonomously or a section autonomously and another section in remote-controlled fashion) within a parking facility in order to park in a parking position. That is to say that in the context of an AVP process there is a provision, for example, for the motor vehicle to drive automatically from a drop-off position, at which a driver of the motor vehicle parked the motor vehicle for the performance of an AVP process, to a parking position and parks there automatically. According to one specific embodiment, an AVP process comprises that the motor vehicle drives automatically from a parking position to a pickup position and parks there automatically, where a person is again able to take over the motor vehicle.

In the context of driverless travel, it is thus no longer necessary for a human driver to be located in the motor vehicle itself in order to drive the motor vehicle.

The present invention will be explained in greater detail in the following with reference to preferred exemplary embodiments.

### BRIEF DESCRIPTION OF THE DRAWINGS

FIG. 1 shows a flow chart of a method for reducing a risk of a collision of a motor vehicle with an object.

FIG. 2 shows a device for reducing a risk of a collision of a motor vehicle with an object.

FIG. 3 shows a motor vehicle.

FIG. 4 shows a parking facility.

FIG. 5 shows the motor vehicle 301 while driving within a parking facility.

### DETAILED DESCRIPTION OF EXAMPLE EMBODIMENTS

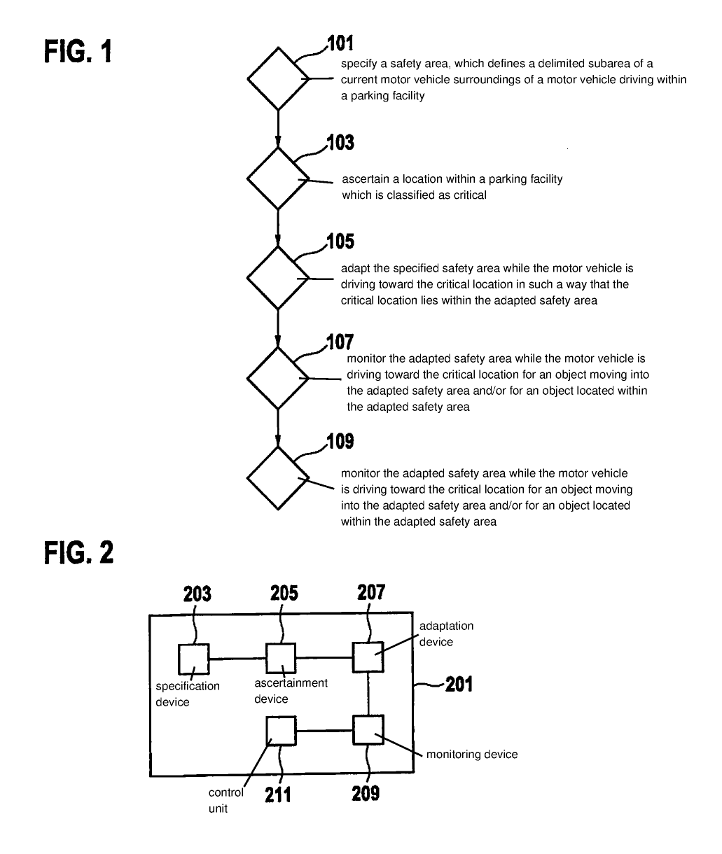

FIG. 1 shows a flow chart of a method for reducing a risk of a collision of a motor vehicle with an object.

The method includes the following steps:
specifying 101 a safety area, which defines a delimited subarea of a current motor vehicle surroundings of a motor vehicle driving within a parking facility,
ascertaining 103 a location within a parking facility which is classified as critical,
adapting 105 the specified safety area while the motor vehicle is driving toward the critical location in such a way that the critical location lies within the adapted safety area,
monitoring 107 the adapted safety area while the motor vehicle is driving toward the critical location for an object moving into the adapted safety area and/or for an object located within the adapted safety area,
controlling 109 a performance of one or multiple safety actions based on the monitoring in order to reduce a risk of a collision of the motor vehicle with the object.

FIG. 2 shows a device 201 for reducing a risk of a collision of a motor vehicle with an object.

Device 201 includes:
a specification device 203 for specifying a safety area, which defines a delimited subarea of a current motor vehicle surroundings of a motor vehicle driving within a parking facility,
an ascertainment device 205 for ascertaining a location within a parking facility which is classified as critical,
an adaptation device 207 for adapting the specified safety area while the motor vehicle is driving toward the critical location in such a way that the critical location lies within the adapted safety area,
a monitoring device 209 for monitoring the adapted safety area while the motor vehicle is driving toward the critical location for an object moving into the adapted safety area and/or for an object located within the adapted safety area,
a control unit 211 for controlling a performance of one or multiple safety actions based on the monitoring in order to reduce a risk of a collision of the motor vehicle with the object.

According to one specific embodiment, device 201 comprises one or more surround sensors.

According to one specific embodiment, device 201 comprises a communication interface for communicating via a communication network.

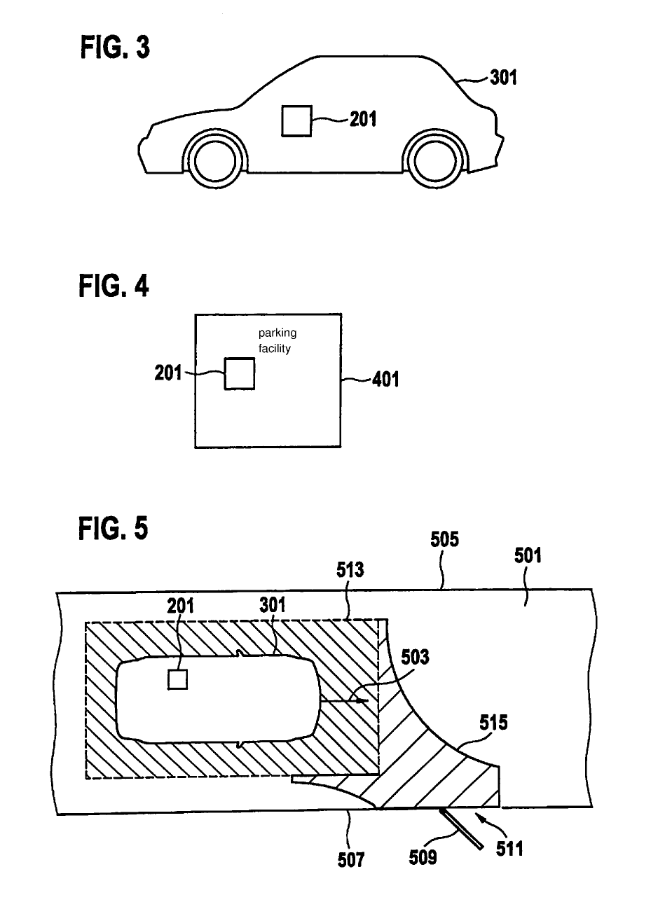

FIG. 3 shows a motor vehicle 301, which comprises device 201 from FIG. 2. For the sake of clarity, elements 203, 205, 207, 209, 211 in device 201 are not shown.

According to one specific embodiment, motor vehicle 301 comprises one or more surround sensors.

According to one specific embodiment, motor vehicle 301 comprises a communication interface for communicating via a communication network.

FIG. 4 shows a parking facility 401 for motor vehicles, parking facility 401 comprising device 201 from FIG. 2. For the sake of clarity, analogous to FIG. 3, elements 203, 205, 207, 209, 211 in device 201 are not shown.

According to one specific embodiment, parking facility 401 includes one or more surround sensors.

According to one specific embodiment, parking facility 401 includes a communication interface for communicating via a communication network.

Device 201 of parking facility 401 is comprised for example by a parking facility management system, which is not shown. A parking facility management system coordinates and controls an operation of parking facility 401. A parking facility management system for example controls AVP processes for motor vehicles.

FIG. 5 shows motor vehicle 301 while driving in a lane 501.

Lane 501 is comprised for example by parking facility 401 from FIG. 4.

A driving direction of motor vehicle 301 is denoted symbolically by an arrow bearing reference numeral 503. A wall 505 is located to the left of motor vehicle 301 relative to driving direction 503. Another wall 507 is located to the right of motor vehicle 301 relative to driving direction 503. Wall 507 on the right has an opening 511, which may be closed by a door 509. The door 509 shown in FIG. 5 is in an open position. That is to say that for example persons may step through opening 511 into lane 501. Opening 511 is thus a critical location.

For this reason, the present invention provides for the adaptation of a specified safety area in order to monitor the area in front of opening 511 in lane 501 and to monitor opening 511 itself to the extent that this is technically possible.

The specified safety area is represented here by a partially dashed line and has a rectangular shape and is indicated by reference numeral 513. This specified safety area 513 is enlarged in order to include the critical location, that is, the location in front of opening 511. The enlarged or adapted safety area is indicated by reference numeral 515.

That is to say that this enlarged or adapted safety area 515 comprises both the originally specified safety area 513 as well as an appropriately enlarged section, which in FIG. 5 is indicated by different shading than the shading of original safety area 513 and which for reasons of clarity is labeled by reference numeral 517.

The present invention thus makes it possible to efficiently reduce a risk of a collision of a motor vehicle with an object.

In accordance with the present invention, by way of a safety area, which is dynamically adaptable in terms of its size, a check is performed to determine whether an object (motor vehicle, human being, animal) is located in a known and/or detected hazardous position (critical location). Such a critical location may be called a “hazard point”. The present invention provides for a shape and/or size of a safety area to be dynamically adapted in such a way that this critical location is covered.

Critical locations are for example: doors, exits, entries, barriers, curves and ramps.

One specific embodiment provides for so-called spontaneous critical locations. Such critical locations arise for example when a mobile object for example, for example a person, intends to step into the lane or onto the driving path of the motor vehicle or is already located in the lane or on the driving path. That is to say that when for example a person is detected who steps or will step into the lane between two motor vehicles, then this location is a critical location and will thus be comprised by way of adaptation by the adapted safety area.

According to one specific embodiment, the safety area is oriented toward the critical location. This is analogous for example to an adaptive high headlight beam or adaptive low headlight beam.

According to one specific embodiment, the shape of the adapted safety area is rectangular or oval or round in front of and behind the critical location.

According to another specific embodiment, the rectangular or, respectively, round or oval shape is enlarged for the critical location.

According to one specific embodiment, the adapted safety area is monitored by one or multiple surround sensors. The multiple surround sensors are for example parts of surround sensor systems. For this purpose, according to one specific embodiment, the surround sensors of the motor vehicle or the surround sensors of a parking facility infrastructure or the surround sensors of both the motor vehicle as well as the parking facility infrastructure are used.

One specific embodiment provides on the one hand that a safety area is determined and accordingly adapted and accordingly monitored in the motor vehicle itself. At the same time, this specific embodiment provides that also outside of the motor vehicle, by way of the device of the parking facility, a safety area is accordingly determined and the determined safety area is adapted and the adapted safety area is accordingly monitored.

The results of the two monitoring processes are then used according to this specific embodiment to control the implementation of the one or the several safety actions.

According to other specific embodiments that are not shown, knowledge of the critical location(s), and thus the accordingly necessary change of the shape of the safety area, is provided or triggered as follows:

The critical locations are stored for example in a digital map. The digital map is stored in the motor vehicle for example. The digital map is stored in the parking facility management system, for example, and according to one specific embodiment is transmitted from the parking facility management system to the motor vehicle via a communication network. The digital map thus provides knowledge about the critical location and thereby triggers an adaptation of the safety area.

According to one specific embodiment, a trigger signal is transmitted from the parking facility management system to the motor vehicle which specifies where there is a critical location in the surroundings of the motor vehicle.

If the motor vehicle detects (for example by a surround sensor or a surroundings analysis system) a critical location in its surroundings, then this (the detection) is a trigger for an adaptation of the safety area. The motor vehicle for example detects that it is currently on a ramp (for example with the aid of an inclination sensor). The motor vehicle for example detects that there is a door in its surroundings. It does so for example on the basis of image processing of video data of a video sensor of the motor vehicle.

1-21. (canceled)

22. A method for reducing a risk of a collision of a motor vehicle with an object, comprising:
specifying a safety area which defines a delimited subarea of a current motor vehicle surroundings of a motor vehicle driving within a parking facility;
ascertaining a location within a parking facility which is classified as critical;
adapting the specified safety area while the motor vehicle is driving toward the critical location in such a way that the critical location lies within the adapted safety area;
monitoring the adapted safety area while the motor vehicle is driving toward the critical location for at least one of an object moving into the adapted safety area, and an object located within the adapted safety area;
controlling a performance of at least one safety action based on the monitoring to reduce a risk of a collision of the motor vehicle with the object.

23. The method as recited in claim 22, wherein the ascertainment of the critical location comprises reading out a location classified as critical from a digital map of the parking facility.

24. The method as recited in claim 22, wherein the ascertainment of the critical location includes performing a surroundings analysis of surroundings data for possible critical locations, the surroundings data being provided by at least one surround sensor that sensed the current motor vehicle surroundings.

25. The method as recited in claim 24, wherein at least one of a current location of the object on the driving path, and a location at which the object will move into the driving path, is classified as a critical location if the surroundings analysis has determined that an object moved or will move into a driving path of the motor vehicle.

26. The method as recited in claim 23, wherein a location of the parking facility infrastructure element is classified as a critical location if the surroundings analysis has determined that at least one parking facility infrastructure element is located in the surroundings of the motor vehicle, the at least one parking facility infrastructure element being an element from the following group of parking facility infrastructure elements: a door, a ramp, an ingress, an entrance, an egress, an exit, a barrier, a curve, and a pillar.

27. The method as recited in claim 22, wherein the ascertainment of the critical location includes analyzing inclination data of an inclination sensor of the motor vehicle to determine an inclination of the motor vehicle, where, if a detected inclination is greater than or greater than or equal to a predetermined inclination threshold value, a determination is made that the motor vehicle is currently located on a ramp so that the ramp is classified as a critical location.

28. The method as recited in claim 22, wherein the adaptation of the specified safety area includes orienting the specified safety area toward the critical location.

29. The method as recited in claim 22, wherein the adaptation is initiated and performed in response to a trigger signal.

30. The method as recited in claim 22, wherein the predetermined safety area has one of a rectangular shape, a circular shape or an oval shape, and surrounds the motor vehicle at least partially, the adaptation including enlarging the one of the rectangular shape, the circular shape or the oval shape.

31. A device for reducing a risk of a collision of a motor vehicle with an object, comprising:
a specification device for specifying a safety area which defines a delimited subarea of a current motor vehicle surroundings of a motor vehicle driving within a parking facility;
an ascertainment device for ascertaining a location within a parking facility which is classified as critical;
an adaptation device for adapting the specified safety area while the motor vehicle is driving toward the critical location in such a way that the critical location lies within the adapted safety area;
a monitoring device for monitoring the adapted safety area while the motor vehicle is driving toward the critical location for at least one of: (i) an object moving into the adapted safety area, and (ii) an object located within the adapted safety area; and
a control unit for controlling a performance of one or multiple safety actions based on the monitoring in order to reduce a risk of a collision of the motor vehicle with the object.

32. The device as recited in claim 31, wherein, for ascertaining the critical location, the ascertainment device is designed to read out a location classified as critical from a digital map of the parking facility.

33. The device as recited in claim 31, wherein, for ascertaining the critical location, the ascertainment device is designed to perform a surroundings analysis of the current motor vehicle surroundings for possible critical locations.

34. The device as recited in claim 33, wherein the ascertainment device is designed to classify at least one of: a current location of the object on the driving path, and a location at which the object will move into the driving path, as a critical location if the surroundings analysis has determined that an object moved or will move into a driving path of the motor vehicle.

35. The device as recited in claim 33, wherein the ascertainment device is designed to classify a location of the parking facility infrastructure element as a critical location if the surroundings analysis has determined that at least one parking facility infrastructure element is located in the surroundings of the motor vehicle, the at least one parking facility infrastructure element being an element from the following group of parking facility infrastructure elements: a door, a ramp, an ingress, an entrance, an egress, an exit, a barrier, a curve, and a pillar.

36. The device as recited in claim 31, wherein the ascertainment device is designed to analyze inclination data of an inclination sensor of the motor vehicle to determine an inclination of the motor vehicle to ascertain the critical location, the ascertainment device being further designed, if a detected inclination is greater than or greater than or equal to a predetermined inclination threshold value, to determine that the motor vehicle is currently located on a ramp and to classify the ramp as a critical location.

37. The device as recited in claim 31, wherein the adaptation device is designed, for the purpose of adapting the specified safety area, to orient the specified safety area toward the critical location.

38. The device as recited in claim 31, wherein the adaptation device is designed to initiate and perform the adaptation in response to a trigger signal.

39. The device as recited in claim 31, wherein, for adapting a rectangular, circular or oval safety area that surrounds the motor vehicle at least partially, the adaptation device is designed to enlarge the rectangular, the circular or the oval safety area.

40. A motor vehicle, comprising:
a device for reducing a risk of a collision of the motor vehicle with an object, the device including a specification device for specifying a safety area which defines a delimited subarea of a current motor vehicle surroundings of a motor vehicle driving within a parking facility, an ascertainment device for ascertaining a location within a parking facility which is classified as critical, an adaptation device for adapting the specified safety area while the motor vehicle is driving toward the critical location in such a way that the critical location lies within the adapted safety area, a monitoring device for monitoring the adapted safety area while the motor vehicle is driving toward the critical location for at least one of: (i) an object moving into the adapted safety area, and (ii) an object located within the adapted safety area, and a control unit for controlling a performance of one or multiple safety actions based on the monitoring in order to reduce a risk of a collision of the motor vehicle with the object.

41. A parking facility for motor vehicles, comprising:
a device for reducing a risk of a collision of a motor vehicle with an object, the device including a specification device for specifying a safety area which defines a delimited subarea of a current motor vehicle surroundings of a motor vehicle driving within a parking facility, an ascertainment device for ascertaining a location within a parking facility which is classified as critical, an adaptation device for adapting the specified safety area while the motor vehicle is driving toward the critical location in such a way that the critical location lies within the adapted safety area, a monitoring device for monitoring the adapted safety area while the motor vehicle is driving toward the critical location for at least one of: (i) an object moving into the adapted safety area, and (ii) an object located within the adapted safety area, and a control unit for controlling a performance of one or multiple safety actions based on the monitoring in order to reduce a risk of a collision of the motor vehicle with the object.

42. A non-transitory computer-readable storage medium on which is stored a computer program, including program code for reducing a risk of a collision of a motor vehicle with an object, the computer program, when executed by a computer, causing the computer to perform:
specifying a safety area which defines a delimited subarea of a current motor vehicle surroundings of a motor vehicle driving within a parking facility;
ascertaining a location within a parking facility which is classified as critical;
adapting the specified safety area while the motor vehicle is driving toward the critical location in such a way that the critical location lies within the adapted safety area;
monitoring the adapted safety area while the motor vehicle is driving toward the critical location for at least one of an object moving into the adapted safety area, and an object located within the adapted safety area;
controlling a performance of at least one safety action based on the monitoring to reduce a risk of a collision of the motor vehicle with the object.
